(19) United States
(12) Patent Application Publication
(10) Pub. No.: US 2009/0089144 A1
(43) Pub. Date: Apr. 2, 2009

(54) BID BASED ADVERTISING TO TELECOMMUNICATION DEVICES

(76) Inventor: Rickey Edward Hodge, JR., Wichita, KS (US)

Correspondence Address: Rickey Edward Hodge, JR., 1317 N VALLEYVIEW, Wichita, KS, 67212, US

(21) Appl. No.: 11/865,074

(22) Filed: Oct. 1, 2007

(51) Int. Cl. G06F 17/00

(52) U.S. Cl. 705/10

(57) ABSTRACT

A method whereby a telecommunication device receives a transmitted advertisement from a plurality of advertisers willing pay for the transmission of advertisements, by bidding for priority transmission to a calling party's telecommunication device within one or more cellular networks, whose predetermined attributes match the advertiser's predetermined criteria.

### CROSS REFERENCE TO RELATED APPLICATION

Not applicable

### BACKGROUND OF THE INVENTION

1. Technical Field of the Invention:

The present invention relates, generally, to the existing and evolving cellular communications network and land based public switching telephone network (PSTN), and particularly, to systems, devices, and methods for establishing a plurality of advertisers that will pay for the transmission of advertisements, by bidding for priority transmission to a calling party's cellular communications device within one or more cellular networks, whose predetermined attributes match the advertiser's predetermined criteria, and the calling party receiving discounted or free cellular service in exchange for being subjected to said advertisement.

2. Background

Cellular telecommunication industry service providers consistently compete to retain existing business, while attracting new business, from more than two-hundred million U.S. cellular telecommunication service subscribers. In addition to voice communications over cellular networks, many cellular telecommunication subscribers utilize cellular data services such as short messaging service (text messaging), video messaging, and web browsing. Subsequently, Americans now spend more time communicating via a cellular telecommunication device than ever before, however, the cost associated with cellular voice and data service for the average consumer can be excessive due to the capital required for cellular telecommunication companies to build and maintain these complex cellular and wire-line telecommunication and data networks. The price consumers must pay to utilize these services reduces the amount of disposable income that may exist for the purchase of other consumer goods. This reduction of disposable income stymies growth in other areas of the American economy.

As such, a method for utilizing free market economics and voluntary subsidization of calling party expenses would reduce the overall burden consumers currently have in paying for cellular telecommunication services. Subsidization may be made by reduced communication equipment and maintenance costs, credits to calling party billing statements, or free use of communication air time for the cellular telecommunication service subscriber. This subsidization would promote economic growth in other industry sectors within the U.S. economy.

Accordingly, there exists a need for material benefits to be derived by parties who would voluntarily subsidize cellular telecommunication services to consumers. One proposed means for parties to derive a material benefit for said subsidization would be for the subsidizing party to transmit advertisement messages, by way of voice, video, and text, to the consumer's cellular telecommunication device. The consumer who utilizes the subsidized cellular telecommunication service would realize additional disposable income while the subsidizing party enjoys the benefit of promoting its products or services. Additionally, the consumer may conceivably expend a portion of its additional disposable income to purchase products or services that the subsidizing party is promoting.

### SUMMARY OF THE INVENTION

The present invention consists of a system, process and method by which an advertisement is selected to be transmitted to a calling party's telecommunication device based upon the highest bidding advertiser's predefined criteria matching, in whole or in part, the profile of the calling party, and that advertiser's advertisement being transmitted to the calling party's telecommunication device in the telecommunication network.

The system, process, and method consists of a telecommunication network receiving a call from a calling party's telecommunication device, said call containing calling and called party information; the telecommunication network comparing information received from the calling party's cellular telecommunication device to triggering criteria and triggering the suspension of the call routing process if the information received matches the triggering criteria.

The telecommunication network, after suspending the call process, queries a network operated or third-party service control point to await call routing instruction. The service control point then selects an advertisement based upon one or more attributes of a sponsor in relation to the calling party's transmitted information and transmits the advertisement to the calling party's telecommunication device.

Upon completing the transmission of the advertisement, the service control point instructs the telecommunication network to release the suspended call process of the calling party's original call and to proceed with routing the calling party's call to the called party.

The calling party's call is subsidized in exchange for the calling party agreeing to receive the highest bidding advertiser's advertisement.

### BRIEF DESCRIPTION OF THE DRAWINGS

For a more in depth understanding of the invention at hand, and the benefits thereof, reference is made to the following figures as follows:

FIG. 1 is a depiction of a common wireless or cellular telecommunication network;

FIG. 2 is a depiction of the method for routing the flow of data and advertisement transmissions for the present invention;

FIG. 3 is an exploded diagram illustrating the data and advertisement transmission directed by service control logic within a self-contained key component of the present invention; and

FIG. 4 is a diagram illustrating the relevancy matching process of sponsor campaigns to subscriber profiles for advertisement selection and transmission.

### DETAILED DESCRIPTION OF THE INVENTION

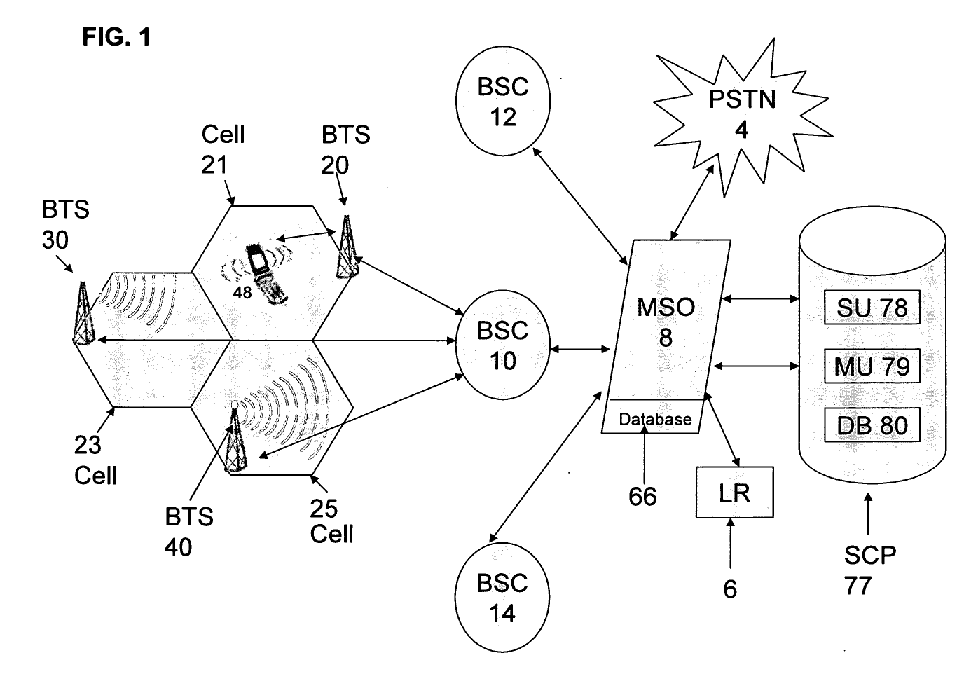

Now refer to FIG. 1, a diagram of a standard cellular communication network is depicted. A mobile switching office (MSO) 8 connects with base station controllers (BSC) 10, 12, and 14. In common practice, BSC 10, 12, and 14 would each connect to multiple base stations (BTS). Referencing FIG. 1, it can be determined that BSC 10 connects to and controls BTS 20, BTS 30, and BTS 40. The BTSs are arranged and grouped in a cellular telecommunication industry standard format for data transmission and reception within a cell site and said cell sites are identified by numerical reference 21, 23 and 25. In practice, BSC numbers 12 and 14, in addition to others, would be connected to other BTSs so as to form a grid of cells for telecommunication voice and data transmission. The additional BTS's relating to BSC numbers 12 and 14 are not depicted in FIG. 1. A cellular telecommunication device 48 is located within cell 21 and communicates with BTS 20. The cellular telecommunication device 48 may pass from cell 21 to other cells and communicate with the BTSs located in those cells. Additionally, the cellular network consists of a location register (LR) 6 that connects to the mobile switching office (MSO) 8. The MSO further connects to the public switching telephone network (PSTN) 4 that connects to other cellular and wire-line telecommunication networks. A network operated or third-party service control point (SCP) 77 is also connected to the mobile switching office 8. The SCP 77 comprises of one or more signaling units (SU) 78, one or more media units (MU) 79, and one or more database units (DB) 80.

The LR 6 is a database that stores specific data pertaining to each cellular telecommunication device 48. The data contained in the LR 6 may consist of the cellular telecommunication device's 48 geographic location, equipment identification number, subscriber identification number, and triggering criteria. When a call is made from the cellular telecommunication device 48 data is transmitted to the MSO 8. The transmitted data consists of pertinent information whereby the cellular telecommunication device identification number comprises a prominent part. This identification number corresponds to the cellular telecommunication device 48 and acts as a unique identifier of that particular cellular telecommunication device 48. The identification information is transmitted to the LR 6. The LR 6 then relays the important data, including identification data, to the MSO 8 for call routing and processing.

When the MSO 8 receives the incoming call data and request for transmission from the calling party's cellular telecommunication device 48, the MSO 8 communicates with a triggering database 66 to determine if data contained in the incoming call matches data contained in the triggering database 66. If the data transmitted to the MSO 8 from the calling party's cellular telecommunication device 48 does not match the data contained within the triggering database 66 one of many alternative options for non-triggering call resolution such as transmission of the call to a customer service representative, call forwarding, or call termination may occur.

If the data transmitted from the cellular telecommunication device 48 to the MSO 8 matches the data contained in the triggering database 66 the MSO 8 will suspend the call routing process and invoke a query to a network operated or third-party SCP 77. The SCP 77 utilizes service logic to process service application program requests from the MSO 8. The service application program determines and controls the processing of the incoming call from the calling party's cellular telecommunication device.

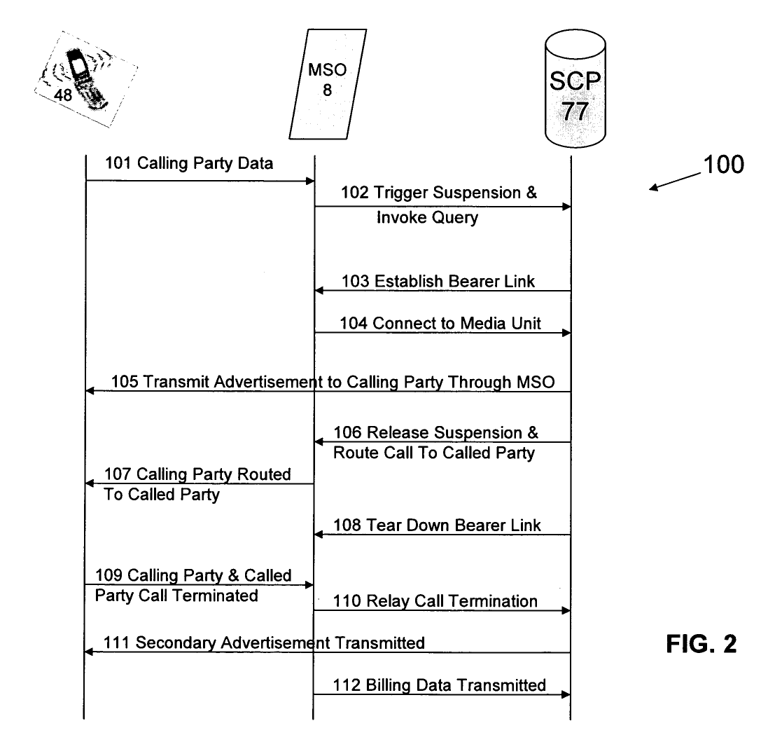

Now refer to FIG. 2, a depiction of the call routing and processing method 100 for this invention can be seen. The cellular telecommunication device 48 establishes a communication link with the MSO 8 and transmits the calling party data identified in FIG. 2 by numeral 101 to the MSO 8. Calling party data consists of cellular telecommunication device 48 identification data, call location data, calling party mobile identification number, and other pertinent data commonly transmitted in accordance with telecommunication standards.

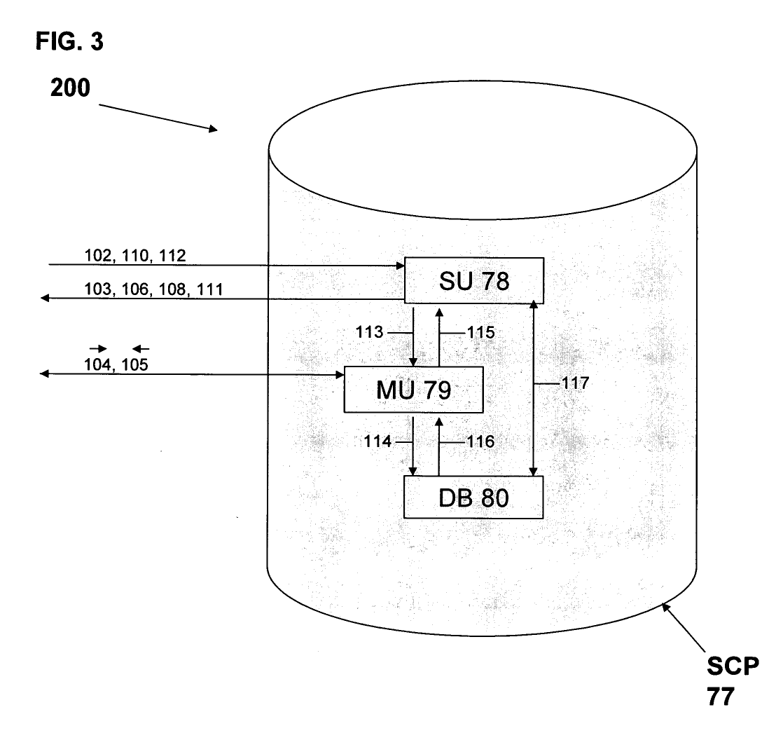

The triggering function occurs when calling party data is transmitted to the MSO 8 and the calling party data matches one or more aspects of data contained in the triggering database 66. If the triggering function occurs, the MSO 8 suspends the calling party's call routing process to the called party and invokes a network operated or third-party SCP 77 service logic program to determine how to handle the calling party call. The MSO 8 transmits the calling party data to the SCP 77 as illustrated by numeral 102 and the SCP 77 processes the call utilizing the parameters established in the service application program. Illustrated more fully in FIG. 3 and described in more detail in subsequent paragraphs, the service application program, among other functions, selects the subscriber profile 261 from the subscriber database 260 that corresponds to the calling party cellular telecommunication device and selects an appropriate sponsor campaign 281 containing an advertisement for transmission to the calling party's cellular telecommunication device 48 from the sponsor database 280.

The SCP 77 relays a message to the MSO 8 to establish a communications link between the MSO 8 and the SCP 77 as referenced by numeral 103. Subsequent to this communication request made by the SCP 77 the MSO 8 responds by establishing a communication link with the SCP 77 as depicted in numeral 104. Upon completion of the establishment of the communication link between the MSO 8 and the SCP 77, the SCP 77 transmits the advertisement 105 attributed to the sponsor campaign 281 selected by the service application program in relation to the calling party data transmitted by the cellular telecommunication device 48 that identifies the subscriber profile 261 contained in the subscriber database 260.

Upon completion of the transmission of the advertisement 105 to the calling party's cellular telecommunication device 48 by the SCP 77 through the MSO 8, the SCP 77 service application program instructs the MSO 8 to release the suspension of the calling party's call processing and to route the calling party to the called party destination 106 whereby the MSO 8 releases the call suspension and utilizes standard telecommunication call processing to route the call to the desired location identified by the calling party in the calling party data transmitted by the cellular telecommunication device 48 in reference numeral 101.

Upon completion of the MSO 8 establishing a communications link between the calling party cellular telecommunication device 48 and the called party in numeral 107 the SCP 77 instructs the MSO 8 to release the communications link between the MSO 8 and the SCP 77 in numeral 104. The phrase “tear down the bearer line” is understood by those skilled in the art to reference the release of the communications link as identified in numeral 108.

At such time as the calling party cellular telecommunication device 48 and the called party's communication link or bearer line is torn down or released and the parties' call is terminated as set out in numeral 109, the MSO 8 will relay this call termination information 110 to the SCP 77 for processing of calling party transmission start and stop time. The SCP will initiate the transmission of a secondary advertisement 111 comprising of audible voice, simple text, video, or combination thereof to the calling party's cellular telecommunication device 48 utilizing a communication link established through the MSO 8. The MSO 8 then transmits billing data 112 to the SCP 77 for record keeping, subscriber billing, call management, and audit purposes.

A simple means of describing method 100 is to say that when a cellular telecommunication device transmits a call to a cellular telecommunication network the network looks to see if data transmitted from the cellular telecommunication device contains information that can be found in a triggering database that would authorize the network to suspend the normal call routing process and invoke a program controlled by the network operated or third-party device to select and transmit an advertisement to the cellular telecommunication device based upon the relevancy match of criteria specified by an advertiser in its advertising campaign and the subscriber profile registered to the cellular telecommunication device that was created by the calling party. After transmission of the advertisement the network call suspension is released and the calling party is routed to its called party destination. The third-party device bills the advertiser's account for transmitting the advertisement to the calling party. After the calling party's call to the called party is complete the network operated or third-party device sends an additional advertisement to the calling party's cellular telecommunication device and the calling party enjoys free or discounted cellular telephone service.

Now referring to FIG. 3, an illustration 200 is presented that comprises of a component view of the SCP 77. The signaling unit (SU) 78 is utilized to transmit, receive, and process non-media based (silent) services such as SS7 messages sent by the MSO 8, it then processes service application program requests by querying the database (DB) 80.

The media unit (MU) 79 provides media resources to the MSO 8 such as, but not limited to, audible advertisement transmission when a bearer line (voice telecommunication link) is established between the MU 79 and the MSO 8. The DB 80 performs database functions such as, but not limited to, calling party look up, subscriber database 260 hosting, sponsor database 280 hosting, billing data storage, and ad-hoc queries.

The method 200 for service application processing occurs between the numerals depicted in FIG. 2. Upon completion of numeral 102 but before numeral 103 the SU 78 queries DB 80 utilizing a multi-purpose communication link referenced by numeral 117 to transmit calling party data to the DB 80 for subscriber profile selection 261. Once the subscriber profile 261 is selected the DB 80 relays the information to the SU 78. The SU then communicates utilizing a multi-purpose communication link 113 with the MU 79 to open a bearer line or communications link between itself and the MSO 8. The SU 78 subsequently sends instruction to the MSO 8 to establish a bearer link with the MU 79 as identified in numeral 103. The MU 79 informs the SU 78 of the completion of the establishment of the bearer link in numeral 104 by transmitting a message utilizing multi-purpose communication link 115. The SU 78 then instructs the MU 79 to select a specific advertisement attributed to a sponsor campaign contained within DB 80 utilizing the multi-purpose communication link identified by numeral 113. The MU 79 then transmits a communication 114 to the DB 80 requesting that the advertisement attributed to a specific sponsor, as determined by the service application program, be relayed 116 to the MU 79 for advertisement transmission to the calling party cellular telecommunication device 48 in numeral 105. Subsequent to the transmission of the advertisement the MU 79 will then relay a completion message utilizing the multi-purpose communication link 115 to the SU 78. The SU 78 will relay a silent message to the MSO 8 to tear down the bearer link as depicted in numeral 108. The SU 78 will also instruct the MU 79 to release or tear down the bearer link established in numeral 104 between itself and the MSO 8 utilizing the multi-purpose communication link 113. The SU then waits to receive the silent data transmitted by the MSO 8 to the SU 78 in numeral 110 so that the SU 78 may transmit the secondary advertisement 111 utilizing the data it received from DB 80 in the prior communication utilizing multi-purpose link 117. Upon completion of the transmission of the secondary advertisement 111 the SU 78 awaits the transmission of billing data from the MSO 8 to the SU 78 so that the SU may relay this billing data to the DB 80.

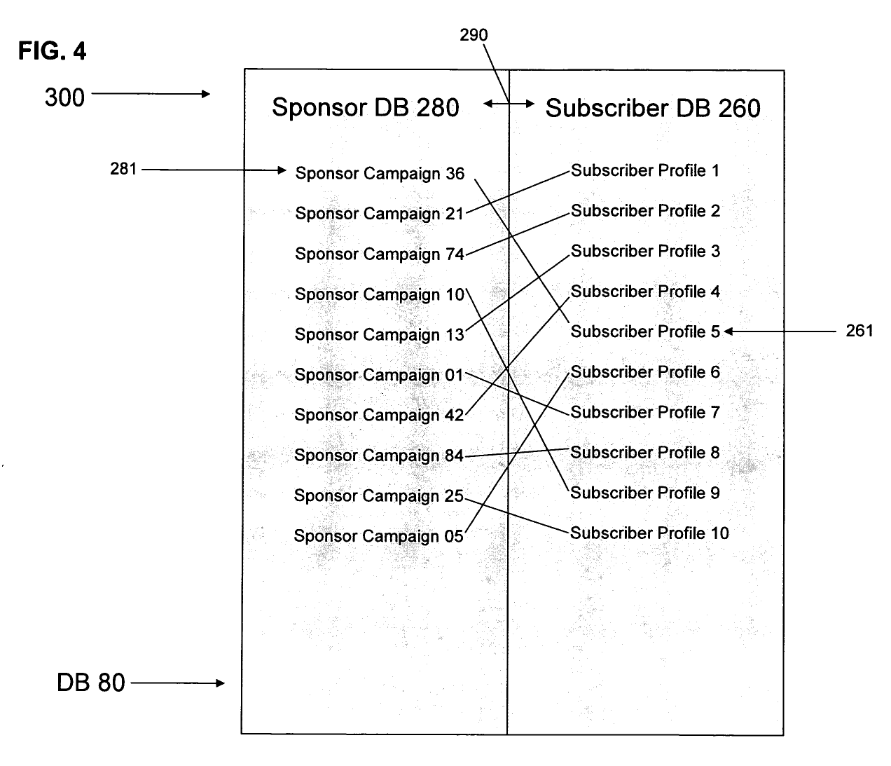

Now referring to FIG. 4, an illustration 300 is presented for the selection of a subscriber profile 261 relating to a calling party cellular telecommunication device 48 and the selection of the most relevant sponsor advertising campaign 281 whose target subscriber criteria matches the subscriber profile attributed to the calling party cellular telecommunication device 48. Additionally, the method for selecting an advertisement to be transmitted to a calling party's cellular telecommunication device 48 utilizing predefined criteria from both the calling party subscriber profile and the sponsor advertising campaign is depicted.

The MSO 8 receives calling party data from the cellular telecommunication device 48 by way of the BTS 20 and the BSC 10. The calling party data is utilized to trigger the suspension of the call routing process and invoke the service application program of a network operated or third-party SCP 77. This service application program controls the advertisement selection process from sponsor advertising campaigns 281 stored in the sponsor database 280 and the transmission of the advertisement to the calling party's cellular telecommunication device 48. A sponsor advertising campaign 281 is selected based upon characteristics attributed to the calling party's cellular telecommunication device 48, as defined by the calling party in the subscriber profile 261 stored in subscriber database 260, that matches the predefined characteristics and profile of a sponsor's advertising campaign 281, and said campaign comprising of the highest monetary bid to broadcast an advertisement to a calling party whose characteristics or profile most closely resemble a sponsor advertising campaign's 281 target market. The sponsor advertising campaign 281 additionally comprises of characteristics such as target market income, age, gender, marital status, geographic location, and any other criteria for identifying particular cellular telecommunication device user attributes.

Cellular telecommunication device 48 characteristics, predetermined by the calling party by creating a subscriber profile 261 and storing said subscriber profile 261 in the subscriber database 260 when the calling party first subscribes to the cellular telecommunication network, consist of personal information, demographics, and preferential criteria selected by the registered owner of the cellular telecommunication device 48 upon subscribing to a telecommunication network for cellular or cellular telephone service. These cellular telecommunication device characteristics 48 may consist of, but are not limited to, the registered owner's age, gender, height, annual income, education level, race, marital status, or any other information that may be utilized to match sponsor campaigns with the overall profile or individual characteristics of the registered owner of the cellular telecommunication device 48.

Additionally, characteristics of the cellular telecommunication device 48 may be utilized to match an incoming call with a sponsor's advertising campaign. The cellular telecommunication device characteristics may include, but are not limited to, the time of day that the cellular telecommunication device transmits calling party data and/or called party data to the MSO 8, the calculated location and/or cell site of the cellular telecommunication device 48, or other data transmitted to the MSO 8 that is attributable to the cellular telecommunication device 48.

The DB 80 relevancy matches 290 all active sponsor advertising campaigns contained in the sponsor database 280 that have one or more variables or criteria matching active subscriber profiles then existing in the subscriber database 260. This indexing constantly occurs and is an independent action to any database inquiry for subscriber profiles, advertisement transmission, and call processing. When the SCP 77 receives the calling party data, the calling party's subscriber profile 261 is retrieved from the subscriber profile database 260 contained in the DB 80 utilizing the calling party's mobile identification number or some other unique identifier contained in the calling party data.

Considering the DB 80 has indexed and relevancy matched the entirety of the sponsor advertising campaigns relevant to the selected subscriber profile 261, at the moment the SU 78 queries the DB 80, the DB 80 is able to select the corresponding sponsor campaign 281 possessing the highest monetary bid by the sponsor for transmission of its advertisement to the calling party whose subscriber profile 261 most closely matches the target market of the particular sponsor. This sponsor advertisement that corresponds to the relevancy matched sponsor campaign selected by the DB 80 is the advertisement relayed to MU 79 in numeral 116 for transmission to the calling party's cellular telecommunication device 48.

The sponsor campaign 281 residing in the sponsor database 280 consists of selectable options that mirror the criteria selectable by the calling party when creating its subscriber profile 261 residing in the subscriber database 260 that is triggered by unique calling party data transmitted by the cellular telecommunication device 48. The sponsor advertising campaign consists of additional criteria that are identifiable and matched to data transmitted by the cellular telecommunication device 48 such as, but not limited to, calling party location, calling party time of day, and calling party date. The sponsor advertising campaign 281 may also consist of unique data such as start and stop dates, daily advertising maximums and minimums, or monetary budgets to control spending. The sponsor advertising campaign 281 consists of a maximum monetary payment amount (bid) that the sponsor is offering to pay for the transmission of its advertisement to calling parties whose subscriber profile 261 matches, in whole or in part, the criteria predefined by the sponsor in its sponsor advertising campaign 281. Multiple sponsors compete against each other for top positioning based upon their maximum bid amounts in a manner that closely resembles a live or internet based auction.

The advertisement of the sponsor campaign 281 comprises of one or more recorded or computer generated audible messages created by the sponsor or a third-party that may be transmitted or played to the calling party if the sponsor's campaign is selected as described and illustrated in FIG. 4 and the text in support thereof contained within this document. The sponsor campaign 281 may also comprise one or more text messages and/or one or more video messages, with or without audio, to be transmitted to the calling party in place of, or in addition to, the recorded or computer generated audible message transmitted to the calling party's cellular telecommunication device 48.

The invention described herein is applicable to any cellular, wireline, or wireless telecommunication network, and although the invention has been described in specific detail with supporting illustrations, it will be understood by those skilled in the art that this invention is not limited to the application(s) depicted but is able to expand or contract without detracting from the premise and nature of the invention as stated in the appended claims.

What is claimed is:

1. A method for selecting and transmitting an advertisement to a user in a telecommunication system, comprising the steps of:
receiving a call from a telecommunication device, the call comprising call origination information; comparing the call origination information to triggering criteria and triggering if the call origination information meets the triggering criteria, the call origination information including data uniquely identifying the cellular telecommunication device;
selecting an advertisement based on one or more sponsor attributes in response to the triggering, the step of selecting the advertisement based on one or more sponsor attributes in response to the triggering, comprising the steps of:
validating the call origination data transmitted by the telecommunication device using the data transmitted by the telecommunication device;
selecting the advertisement based on a bid placed by a sponsor; and
transmitting the selected advertisement to be received by the telecommunication device.

2. The method in accordance with claim 1 wherein the call origination information includes telecommunication device identification data uniquely identifying the telecommunication device, and wherein the step of triggering comprises the steps of comparing the identification data to a database comprising a plurality of predetermined identification numbers and triggering if the data transmitted by the telecommunication device is equal to one of the plurality of predetermined identification numbers within the database.

3. The method in accordance with claim 1 wherein the call origination information includes called number data, and wherein the step of triggering comprises the steps of comparing the called number data to a database comprising a plurality of predetermined called numbers and triggering if the called number data of the subscriber station is equal to one of the plurality of predetermined called numbers within the database.

4. The method in accordance with claim 1 wherein the call origination information includes called party information, and the method further includes the step of requiring the service control point to instruct the mobile switching office to release the suspension of the calling party's original call and to process the call to the original destination defined by the transmitted called party information after the selected advertisement is transmitted.

5. The method in accordance with claim 1 wherein the call origination information includes telecommunication device identification data uniquely identifying the telecommunication device.

6. The method in accordance with claim 1 wherein the selected advertisement is an audible announcement, video, image, text display or any combination of the aforementioned methods.

7. The method in accordance with claim 1 wherein the one or more attributes includes location data that identifies the location of the telecommunication device and the selected message is selected based on the location of the telecommunication device.

8. The method in accordance with claim 7 further comprising the step of generating the location data based on the location of the telecommunication device.

9. The method in accordance with claim 1 wherein one or more sponsor attributes are created by establishing an advertising campaign, comprising the steps of:
a sponsor identifying criteria to be used, in whole or in part, to determine to what telecommunication device the advertisement is to be transmitted;
the sponsor establishing a monetary bid amount that it is willing to pay to have the advertisement transmitted to a telecommunication device; and
the sponsor establishing the advertisement to be transmitted.

10. The method in accordance with claim 1 wherein the advertisement is selected based on one or more predefined criteria associated with a particular advertising campaign and telecommunication device profile using a relevancy match and bid selection process, comprising the steps of:
relevancy matching the sponsor's advertising campaign criteria and bid amount with existing telecommunication device profiles; and
selecting an advertisement based on the relevancy match and on the location of the cellular telecommunication device.
